(19) United States
(12) Patent Application Publication
(10) Pub. No.: US 2010/0129706 A1
(43) Pub. Date: May 27, 2010

(54) DEVICE WITH AT LEAST ONE ACCUMULATOR CELL

(75) Inventor: Wolf Matthias, Stuttgart (DE)

Correspondence Address: MERCHANT & GOULD PC, P.O. BOX 2903, MINNEAPOLIS, MN, 55402-0903, US

(73) Assignee: Robert Bosch GMBH, Stuttgart (DE)

(21) Appl. No.: 12/622,452

(22) Filed: Nov. 20, 2009

(30) Foreign Application Priority Data
Nov. 21, 2008 (DE) 10 2008 043 960.6

(51) Int. Cl. H01M 2/00

(52) U.S. Cl. 429/163

(57) ABSTRACT

In the case of a device with at least one accumulator cell having at least one electrode assembly which is disposed in an elastic sheath, the accumulator cell is equipped with an apparatus having at least two retaining elements, which are connected to each other. The accumulator cell is then held at associated hold points by the retaining elements.

This application claims benefit of Serial No. 10 2008 043 960.6, filed 21 Nov. 2008 in Germany and which application is incorporated herein by reference. To the extent appropriate, a claim of priority is made to the above disclosed application.

### TECHNICAL FIELD

The present invention relates to a device with at least one accumulator cell, which has an electrode assembly disposed in an elastic cell sheath.

### BACKGROUND

Accumulators as a rule consist of a plurality of accumulator cells from any desired type of accumulator, such as, for example, NiCd, NiMH and Li-ion, which are connected together in packs or modules. They are therefore also referred to as accumulator packs or accumulator modules. In particular accumulators with Li-ion cells are widely used due to their high specific energy output as well as their high specific energy content. Li-ion cells, as they are, for example, used in electric tools, are typically designed as round cells with a rigid metal sheath. Said round cells do not exhibit an enlargement of their mass, which contributes to the energy supply, due to the metal sheath and lead to dead construction volume in corresponding accumulator packs or modules due to their round construction.

In order to avoid this mass enlargement and the dead construction volume, it is known from the technical field to revert back to so-called “lithium polymer” cells (LiPo cells). These usually have electrode assemblies, which consist of platelet-like electrodes stacked on top of each other. Said electrodes are respectively separated from each other by suitable separators and are disposed in an elastic cell sheath. Such LiPo cells are as a rule prismatic and can consequently be disposed in the housing of an associated accumulator pack or module in order to save space.

The disadvantage in the technical field is that the elastic cell sheath expands when a change in volume of the accumulator cell occurs, for example by means of an excess pressure which occurs when gas forms during operation on account of electrochemical processes inside the cell. This expansion of the cell sheath can however lead to the damage or destruction of one or a plurality of cell sheaths and consequently of the cells, respectively the accumulator packs or modules, in an associated accumulator housing of an accumulator pack or module, wherein a plurality of accumulator cells is stacked one on top of each other. Furthermore, it is difficult to stably and safely accommodate, respectively mount, such accumulator cells in a rigid accumulator housing on account of the elastically deformable cell sheath.

### SUMMARY

It is therefore a task of the invention to provide a device which allows for a stacking of accumulator cells with elastic cell sheaths in an accumulator housing in such a way that damage or destruction of the cell sheaths and consequently the accumulator cells is avoided during their operation.

This problem is solved by a device with at least one accumulator cell, which has an electrode assembly disposed in an elastic cell sheath. The accumulator cell is equipped with an apparatus, which has at least two retaining elements which are connected to each other, the accumulator cell being held by the retaining elements at associated hold points.

The invention thereby allows for a simple and uncomplicated installation of accumulator cells in a housing the associated apparatuses as well as for a configuration of stable and safe cell stacks. In so doing, the accumulator cells are in each case spaced apart from each other by the associated apparatuses.

According to one embodiment, the apparatus is configured for the purpose of allowing for an expansion of the cell sheath when a change in volume of the accumulator cell takes place.

Consequently damage to or destruction of the cell sheath and thus the accumulator cell can be prevented when a corresponding change in volume takes place. Provision is thereby also made for the accumulator cells to be fixedly mounted in the accumulator housing.

The retaining elements are preferably configured for the purpose of gripping the accumulator cell at the associated hold points with a predefined holding pressure. The holding elements are connected to each other via at least one crosspiece.

The invention therefore allows for a simple and uncomplicated installation of corresponding apparatuses on associated accumulator cells.

According to one embodiment, the electrode assembly has at least two square, platelet-like electrodes, which are separated from each other by a separator. The apparatus preferably has four retaining elements, the apparatus gripping the electrode assembly at its corners with the retaining elements at a predefined holding pressure. The cell sheath has a rabbet-like extension at least one corner of the electrode assembly. The retaining element associated with at least the one corner preferably has a groove to accept the rabbet-like extension. The groove is configured for the purpose of accepting the rabbet-like extension.

Consequently a simple, safe and stable installation of corresponding apparatuses on associated accumulator cells is made possible.

The retaining elements preferably have first sections, which are provided on the top side of the apparatus and second sections, which are provided on the bottom side of said apparatus. The sections on the top side are configured for holding a first accumulator cell, and the sections on the bottom are configured for holding a second accumulator cell.

Two accumulator cells can therefore be held using one individual apparatus and can be installed safely and stably in an associated accumulator housing.

According to one embodiment a plurality of accumulator cells with associated apparatuses is stacked one on top of the other. In so doing, each apparatus has associated retaining elements, and the retaining elements from two different apparatuses in each case abut on each other.

The problem stated at the beginning of the application is furthermore solved by an apparatus for an accumulator cell, which has an associated electrode assembly in an elastic cell sheath. The electrode assembly has at least two square, platelet-like electrodes, which are separated from each other by a separator. Provision is made for at least four retaining elements which are connected to each other and are configured for the purpose of gripping the electrode assembly at its corners with a predefined holding pressure.

### BRIEF DESCRIPTION OF THE DRAWINGS

The invention is described in detail in the following description with the aid of an example of embodiment depicted in the drawings. The following are shown:

FIG. 1 is a perspective view of a device with an accumulator cell and an apparatus for retaining the cell according to a first embodiment,

FIG. 2 is a perspective view of the device from FIG. 1 when installing the apparatus on the accumulator cell,

FIG. 3 is a perspective view of a cell stack with two accumulator cells and two associated apparatuses for retaining the cells according to the first embodiment,

FIG. 4 is a perspective view of a device with two accumulator cells and an apparatus for retaining the cells according to a second embodiment,

FIG. 5 is a perspective view of the device from FIG. 4 when installing the apparatus on the accumulator cells, and

FIG. 6 is a perspective view of a cell stack with four accumulator cells and two associated apparatuses for retaining the cells according to the second embodiment.

### DETAILED DESCRIPTION

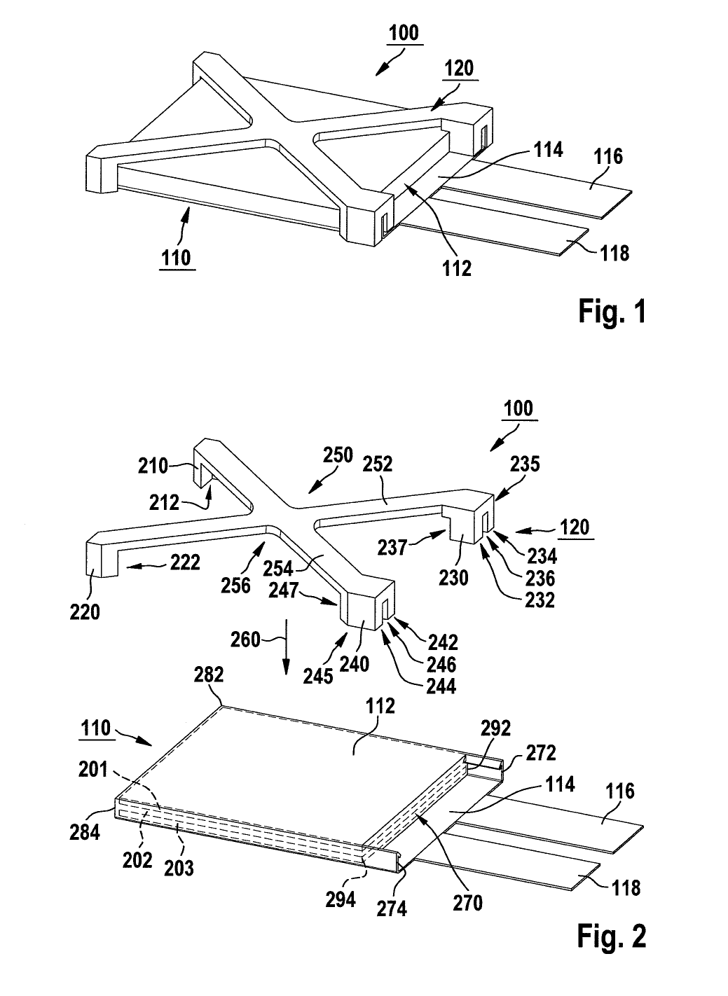

FIG. 1 shows a device 100 with an accumulator cell 110, whereupon an apparatus 120 is attached. The accumulator cell 110 has an elastic cell sheath 114, wherein an electrode assembly 112 is disposed.

The cell sheath 114 is preferably configured from a plastic film, which has an aluminum coating. A suitable plastic film is, for example, constructed from three layers. An inner aluminum layer is then provided between two outer plastic layers. The three layers are preferably welded together.

Electrical contacts 116, 118 are provided for electrically contacting the accumulator cell 110 along with other accumulator cells to an accumulator pack or module, respectively for the external contact-connection of the accumulator cell. Said contacts 116, 118 are electrically conductively connected to the electrode assembly 112 and are led towards, respectively away from, said assembly 112 via the cell sheath 114.

FIG. 2 illustrates an installation of the apparatus 120 on the accumulator cell 110. In this instance, the apparatus 120 is slid onto, respectively slipped onto, the accumulator cell 110, respectively onto its electrode assembly 112, which is disposed in the cell sheath 114, in the direction of an arrow 260.

According to one embodiment, the electrode assembly 112 has two or more square, platelet-like electrodes, which in each case are separated from each other by suitable separators. Two electrodes 201, 203 which are separated from each other by a separator 202 are shown by way of example in FIG. 2.

The electrode assembly 112 is preferably completely enclosed by the cell sheath 114, the cell sheath 114 having rabbets on all edges of the electrode assembly 112, which are preferably glued. The cell sheath 114 preferably has rabbet-like extensions 272, 274, which extend from the corners 292, 294 of the electrode assembly 112, on one edge 270 of the electrode assembly 112.

The apparatus 120 has four retaining elements 210, 220, 230, 240 for the sake of illustration. The retaining elements 210, 240 are provided on a crosspiece 254 and are connected to each other via said crosspiece 254. The retaining elements 220, 230 are provided on a crosspiece 252 and are connected to each other via said crosspiece 252. The crosspieces 252, 254 are arranged in the form of a cross relative to one another and are connected to each other at a point of intersection 250. This point of intersection 250 can be equipped with one or a plurality of reinforcements for the stabilization of the construction.

It should be noted that the apparatus 120 is not limited to the use of four retaining elements 210, 220, 230, 240 but rather can have any number of retaining elements. In this connection, the number of retaining elements can be selected as function of a configuration of the electrode assembly 112. For example, four or more retaining elements or also alternatively only two or three retaining elements can be used as described above in the case of a square configuration of the electrode assembly 112. This is true as long the retaining elements are suited for the purpose of holding the accumulator cell 110 with a sufficient holding pressure, as described below.

It should likewise be noted that the connection of the retaining elements 210, 220, 230, 240 via the intersecting crosspieces 252, 254 is merely described as an example. Other structures are likewise possible within the scope of the present invention. The retaining elements 210, 220, 230, 240 can, for example, be connected to each other via crosspieces which form a frame, or via crosspieces which define a Z-shaped design.

The retaining elements 210, 220 have holding mechanisms 212, respectively 222, which are configured for the purpose of holding the accumulator cell 10 at associated hold points 282, respectively 284. With regard to the accumulator cell 110, suitable corners of the electrode assembly 112 are used as hold points 282, 284. The holding mechanisms 212, 222 are accordingly configured as square recesses, in which the corners 282, respectively 284, of the electrode assembly 112 can be disposed and retained.

The retaining elements 230, 240 have holding mechanisms 235, respectively 245, which are configured for the purpose of holding the accumulator cell 110 at associated hold points which correspond to the corners 292, 294 of the electrode assembly 112. According to one embodiment, the retaining elements 230, 240 have square recesses 237, 247, which preferably are similarly configured to the recesses which constitute the holding mechanisms 212, 222 and in which the corners 292, 294 of the electrode assembly 112 can be disposed. Moreover, the holding mechanisms 235, 245 have outer supporting members 234, respectively 244, whose length preferably corresponds to the length of the holding mechanisms 212, 222, as well as inner supporting members 234, 244 whose length is shortened relative to said outer members 234, 244. The outer supporting members 234, 244 and the inner supporting members 232, respectively 242, are in each case separated from one another by a groove 236, respectively 246. The groove 236, respectively 246, is preferably configured for the purpose of accepting the associated rabbet-like extension 272, respectively 274. In so doing, the extension 272, respectively 274, can be clamped in the groove or can merely be disposed therein.

Starting from a bottom surface of the crosspieces 252, respectively 254, facing towards the accumulator cell 110 in FIG. 2, the inner supporting members 234, 244 have a length, which approximately corresponds to the height of the electrode assembly 112. The length of the outer supporting members 234, 244 as well as the holding mechanisms 212, 222 is greater than the length of the inner supporting members 234, 244 by a predefined distance.

After the installation of the electrode assembly 112, the apparatus 120 according to one embodiment grips the corners 282, 284, 292, 294 of said assembly 112 with the retaining elements 210, 220, 230, 240 at a predefined holding pressure. In order to achieve this holding pressure, the retaining elements 210, 240 are preferably braced against one another by the crosspiece 254; and the retaining elements 220, 230 are preferably braced against one another by the crosspiece 252. In so doing, the crosspieces 252, 254 ensure that a sufficiently large region of the cell sheath 114 remains free on the side of the accumulator cell 110 which faces them in order to allow for an expansion of the cell sheath 114 in this region when a change in volume of the accumulator cell 110 occurs. On the opposite side of the accumulator cell 110 which faces away from the crosspieces 252, 254, a corresponding clearance is created by the overhanging, outer supporting members 234, 244 as well as the holding mechanisms 212, 222, which serve as feet when the accumulator cell 110 is stacked. The rabbet-like extensions 272, 274, which are clamped in the grooves 236, 246 serve thereby to stabilize, respectively improve, the connection between the apparatus 120 and the accumulator cell 110.

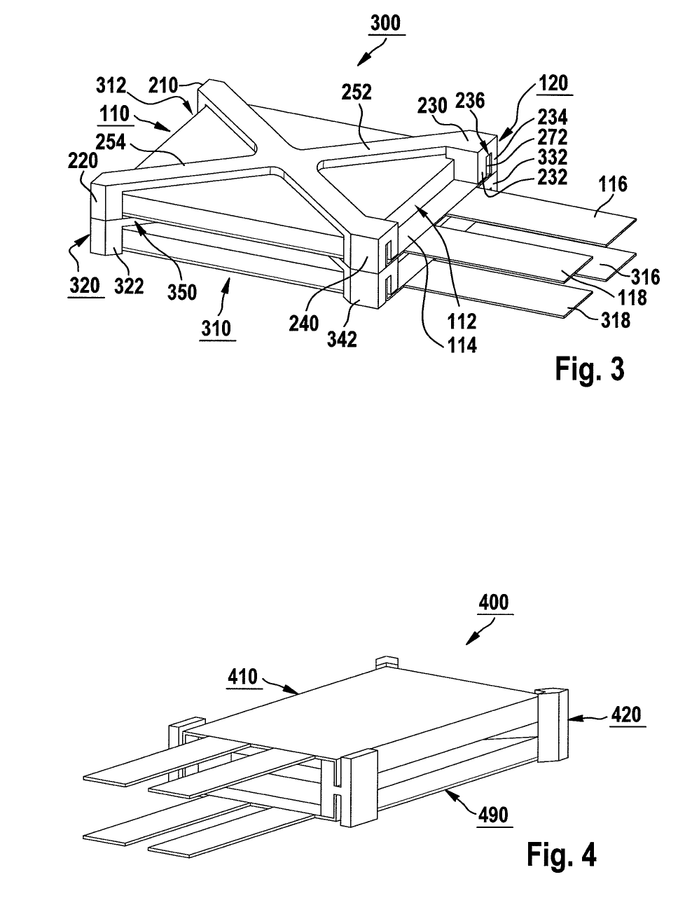

FIG. 3 shows a cell stack 300, wherein the accumulator cell 10 equipped with the apparatus 120 of FIGS. 1 and 2 is exemplary disposed above an accumulator cell 310, which is equipped with a corresponding device 320. According to one embodiment, the configuration of the accumulator cell 310 corresponds to the configuration of the accumulator cell 110 of FIG. 2; and the configuration of the device 320 corresponds to the configuration of the apparatus 120 of FIG. 2 so that a detailed description of these elements can be foregone.

The accumulator cell 310 has electrical contacts 316, 318. These can be connected to the electrical contacts 116, 118 of the accumulator cell 110 or to corresponding external contacts when connecting the accumulator cells 110, 310 to an accumulator pack or module.

FIG. 3 exemplary illustrates how the rabbet-like extension 272 is disposed in the groove 236 which is configured between the inner supporting member 232 and the outer supporting element 234. It can furthermore be seen in FIG. 3 how the retaining elements 210, 220, 230, 240 are disposed on corresponding retaining elements 312, 322, 332, 342 of the apparatus 320, respectively abut on them. In so doing, an arrangement of the crosspieces, which connects the retaining elements 312, 322, 332, 342 to one another, creates a clearance between the accumulator cells 110 and 310, which is increased even more by the clearance described in FIG. 2 on the side of the accumulator cell 110 which faces away from the crosspieces 252, 254.

FIG. 4 shows a device 400 with two accumulator cells 410, 490 which are connected to an apparatus 420. The configuration of the accumulator cells 410 and 490 preferably corresponds to the configuration of the accumulator cell 110 of FIG. 2 so that a detailed description of the accumulator cells 410, 490 can be foregone.

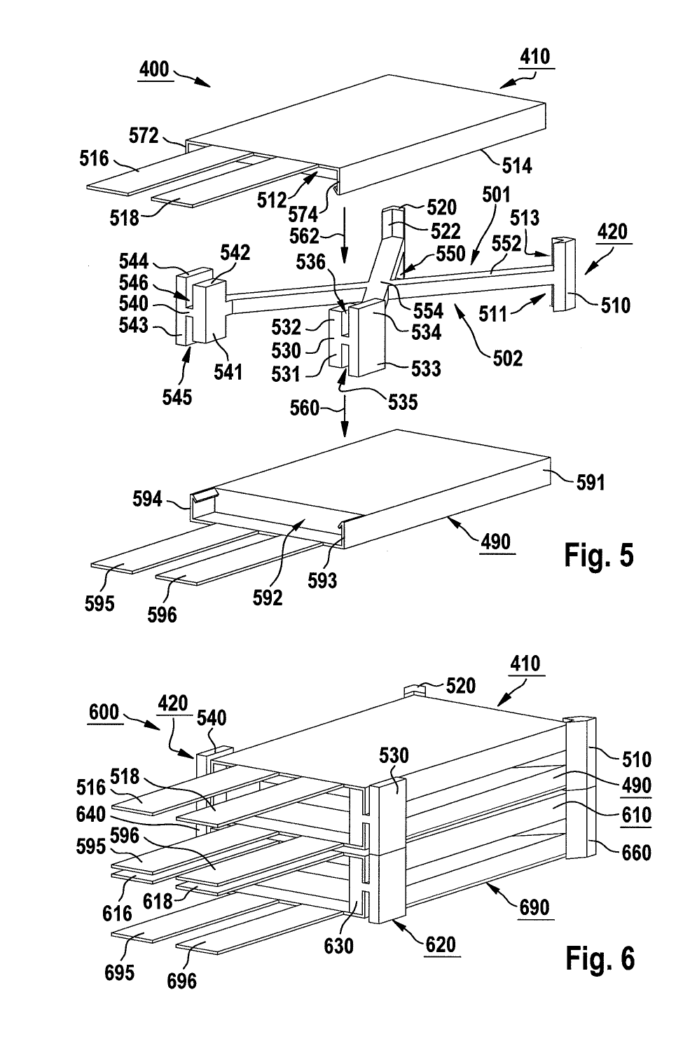

FIG. 5 shows the accumulator cell 410, which is equipped with a cell sheath 514, rabbet-like extensions 572, 574, electrical contacts 516, 518 as well as with an electrode assembly 512 and the accumulator cell 490 of FIG. 4, which is equipped with a cell sheath 591, rabbet-like extensions 593, 594, electrical contacts 595, 596 as well as an electrode assembly 592. FIG. 5 furthermore shows a preferred embodiment of the apparatus 420 of FIG. 4.

The apparatus 420 has four retaining elements 510, 520, 530, 540 for the sake of illustration. The retaining elements 510, 540 are provided on a crosspiece 552 and are connected to each other via said crosspiece 552. The retaining elements 520, 530 are provided on a crosspiece 554 and are connected to each other via said crosspiece 554. The crosspieces 552, 554 are exemplary arranged in the form of a cross relative to each other.

It should be noted that the apparatus 420 like the apparatus 120 from FIG. 2 is not limited to the use of four retaining elements 510, 520, 530, 540; and that the connection of the retaining elements 510, 520, 530, 540 via the intersecting crosspieces 552, 554 is also only described as an example.

The retaining elements 510, 520 have holding mechanisms 511, 513, respectively 522, 550, which, for example, are configured as square recesses like the holding mechanisms 212, 222 of FIG. 2. In this case, the holding mechanisms 513, 522 respectively form a first section of the retaining elements 510, 520, which is provided on the top side 501 of the apparatus 420; while the holding mechanisms 511, 550 respectively form a second section of the holding elements 510, 520, which is provided on a bottom side 502 of the apparatus 420 opposite to the top side 501.

The retaining elements 530, 540 likewise have first and second, respectively upper and lower sections, which according to one embodiment are in each case configured like the retaining elements 230, 240 of FIG. 2. The upper section of the retaining element 530 has, for example, an inner supporting member 532, an outer supporting member 534 as well as a groove 536. The lower section of said retaining element 530 has an inner supporting member 531, an outer supporting member 533 as well as a groove 535. Analogous to this, the upper section of the retaining element 540 has an inner supporting member 542, an outer supporting member 544 as well as a groove 546; and its lower section has an inner supporting member 541, an outer supporting member 543 as well as a groove 545. A detailed description of the retaining elements 510, 520, 530, 540 is however foregone for the sake of brevity of the description.

When installing the accumulator cells 410, 490 on the apparatus 420, the accumulator cell 410 is pressed onto the apparatus 420, respectively slid onto the apparatus 420, in the direction of an arrow 562. For its part, said apparatus 420 is slid onto the accumulator cell 490, respectively pressed onto the accumulator cell 490, in the direction of an arrow 560. In so doing, the apparatus grips the accumulator cells 410, 490 with a predefined holding pressure as exemplary described above in regard to FIG. 2 with reference to the accumulator cell 110 and the apparatus 120. Each of the accumulator cells 410, 490 can thereby expand substantially unimpeded in at least one direction.

FIG. 6 shows a cell stack 600, in which the accumulator cells 410, 490 of FIGS. 4 and 5, which are equipped with the apparatus 420, are disposed by way of example above two accumulator cells 610, 690 which are equipped with an apparatus 620. According to one embodiment, the configuration of the accumulator cells 610, 690 corresponds to the configuration of the accumulator cell 110 of FIG. 2, and the configuration of the apparatus 620 corresponds to the configuration of the apparatus 420 of FIG. 5 so that a detailed description of these elements can be foregone.

The accumulator cell 610 has electrical contacts 616, 618, and the accumulator cell 690 has electrical contacts 695, 696. When connecting the accumulator cells 410, 490, 610, 690 to an accumulator pack or module, said contacts can be connected up to the electrical contacts 516, 518, respectively 595, 596 of the accumulator cells 410, respectively 490, or to corresponding external contacts.

FIG. 6 exemplary illustrates how the retaining elements 510, 520, 530, 540 are disposed on corresponding retaining elements 660, 630, 640 of the apparatus 620, respectively abut on them. When stacking the accumulator cells, which are equipped with apparatuses of the type of apparatus 420, respectively 620, the retaining elements of two different apparatuses consequently abut on each other.

1. A device, comprising:
at least one accumulator cell having one electrode assembly disposed in an elastic cell sheath;
wherein the accumulator cell is equipped with an apparatus having at least two retaining elements connected to each other, the accumulator cell being held at associated hold points by the retaining elements.

2. The device according to claim 1, wherein the apparatus is configured for the purpose of allowing an expansion of the cell sheath when a change in volume of the accumulator cell occurs.

3. The device according to claim 1, wherein the retaining elements are configured for the purpose of gripping the accumulator cell at the associated hold points with a predefined holding pressure.

4. The device according to claim 1, wherein the retaining elements are connected to each other via at least one crosspiece.

5. The device according to claim 4, in which the electrode assembly has at least two square platelet-like electrodes which are separated from each other by a separator, wherein the apparatus has four retaining elements, the apparatus gripping the electrode assembly on its corners with the retaining elements at a predefined holding pressure.

6. The device according to claim 5, in which the cell sheath has a rabbet-like extension with at least one corner of the electrode assembly, wherein the retaining element associated with at least the one corner has a groove for accepting the rabbet-like extension.

7. The device according to claim 6, wherein the groove is configured for the purpose of clamping the rabbet-like extension.

8. The device according to claim 1, wherein the retaining elements have first sections, which are provided on a top side of the apparatus, and second sections, which are provided on its bottom side, the sections on the top side being configured for holding a first accumulator cell and the sections on the bottom side for holding a second accumulator cell.

9. The device according to claim 1, wherein a plurality of accumulator cells with associated apparatuses is stacked one on top of each other. In so doing, each apparatus has associated retaining elements and the retaining elements of two different apparatuses in each case abut on each other.

10. An apparatus for an accumulator cell, which has an electrode assembly disposed in an elastic cell sheath, the electrode assembly having at least two square, platelet-like electrodes which are separated from each other by a separator, wherein a provision is made for at least four retaining elements, which are connected to each other, wherein said retaining elements are configured for the purpose of gripping the electrode assembly on its corners with a predefined holding pressure.
